(19) United States
(12) Patent Application Publication
(10) Pub. No.: US 2007/0183340 A1
(43) Pub. Date: Aug. 9, 2007

(54) Power-line communication system to supply power and data to integrated services digital network (ISDN) subscriber terminal and control method thereof

(76) Inventor: Kwon-Su Kim, Yongin-si (KR)

Correspondence Address: Robert E. Bushnell, Suite 300, 1522 K Street, N.W., Washington, DC, 20005-1202, US

(21) Appl. No.: 11/641,893

(22) Filed: Dec. 20, 2006

(30) Foreign Application Priority Data
Feb. 6, 2006 (KR) 10-2006-0011354

(51) Int. Cl. H04J 1/16

(52) U.S. Cl. 370/252; 370/258

(57) ABSTRACT

A power-line communication system and control method to supply power and data to an Integrated Service Digital Network (ISDN) subscriber terminal includes: a subscriber terminal adapted to transmit a response message upon a connection request message being received; and a power supply switch adapted to transmit the connection request message to the subscriber terminal, and to supply power together with data to the subscriber terminal upon the response message to the connection request message being received from the subscriber terminal. The power supply switch is adapted to cut off the power supplied to the subscriber terminal upon the response message to the connection request message not being received from the subscriber terminal.

### CLAIM OF PRIORITY

This application makes reference to, incorporates the same herein, and claims all benefits accruing under 35 U.S.C.§119 from an application for POWER LINE SYSTEM AND CONTROL METHOD FOR SUPPLING POWER/DATA TO ISDN SUBSCRIBER TERMINAL earlier filed in the Korean Intellectual Property Office on 6 Feb. 2006 and there duly assigned Serial No. 10-2006-0011354.

### BACKGROUND OF THE INVENTION

1. Field of the Invention

The present invention relates to a power-line communication system to supply power and data to an Integrated Service Digital Network (ISDN) subscriber terminal and a control method thereof.

2. Description of the Related Art

A power-line communication system is currently be investigated for use in wired home network technologies.

The Power-Line Communication (PLC) system refers to a technique of converting a communication signal into a high frequency signal, transmitting the converted high frequency signal over existing power lines, which already have been run to many homes and offices, and receiving the signal by isolating the signal using a high frequency filter.

An idea has been suggested that a power line can be used for communication since it is made of copper like a telephone line and has a thickness that is ten times greater than that of the telephone line.

However, while the utilization of the power line as a communication line has not been previously used due to technical problems such as noise, an attenuation phenomenon, and frequent disconnection, the power-line communication is becoming commercialized since an error correction method for removing noise was developed and other technical problems were solved in 1990's.

In particular, since the Consumer Electronics Incorporation of America developed an open technique, a CE-Bus protocol, a variety of power-line communication related enterprises have actively developed products using CE-Bus protocol, and the best advantage of utilizing the power-line communication as home networking and a subscriber network solution is its economical efficiency.

Since the power lines are already installed worldwide, the usage of the power lines enables construction of an indoor/outdoor communication network of home networking and a subscriber network, etc. at low cost, and when the power-line communication is applied to the indoor network, it can be used as middleware, which is a connection medium of the home networking, and an operation system.

Power-line communication products using a middle/low speed technique are used to control electric appliances and illumination devices, and thus, applying the power-line communication to a home networking solution has proliferated.

In particular, since a generalized standard is not determined due to fierce competition among various standards in a home networking field, the power-line communication in a home networking market positions itself as a major communication method in a control networking area.

This is because when the power-line communication is used as a home networking solution, a system can be built at low cost by using an outlet and a switch.

However, a high-speed technique has institutional restrictions such as frequency regulations in addition to the technical problems, and middle- and low-speed techniques also have a problem in that a standard control protocol between a home gateway and a power-line communication modem has not been defined.

### SUMMARY OF THE INVENTION

It is an object of the present invention to supply a power-line communication system for supplying power and data to an ISDN subscriber terminal and a control method thereof capable of eliminating risk factors which can damage human beings and other equipment, and enabling voice and data communication in a region where power usage is not allowed by stably supplying power.

According to one aspect of the present invention, a power-line communication system to supply power and data to an Integrated Service Digital Network (ISDN) subscriber terminal is provided, the system including: a subscriber terminal adapted to transmit a response message upon a connection request message being received; and a power supply switch adapted to transmit the connection request message to the subscriber terminal, and to supply power together with data to the subscriber terminal upon the response message to the connection request message being received from the subscriber terminal.

The power supply switch is preferably adapted to cut off the power supplied to the subscriber terminal upon the response message to the connection request message not being received from the subscriber terminal.

The power supply switch preferably includes; a power supply adapted to supply a reference power; a switch adapted to perform a switching operation to supply power to the subscriber terminal or to cut off the power according to a power supply control signal input; a data detector adapted to detect the response message received from the subscriber terminal; and a data controller adapted to transmit the connection request message to the subscriber terminal to confirm a state of a connection with the subscriber terminal, and to transmit the power supply control signal to the switch to cut off power supplied to the subscriber terminal upon the response message not being received from the subscriber terminal.

The system preferably further includes a power controller adapted to adjust power supplied through the power supply, and to convert the adjusted power to power for each provider.

The data controller is preferably adapted to transmit the power supply control signal to the switch upon the response message being received from the subscriber terminal through the data detector, to thereby supply power to the subscriber terminal. The data controller is preferably adapted to transmit the power supply control signal to the switch upon a connection termination message being received from the subscriber terminal while power is being supplied to the subscriber terminal, the power supply control signal cutting off power supplied to the subscriber terminal.

The connection termination message is preferably at least one of a power-line fault, a subscriber terminal fault, and connection termination of the subscriber terminal.

According to another aspect of the present invention, a method of controlling a power-line communication system to supply power and data to an Integrated Service Digital Network (ISDN) subscriber terminal is provided, the method including: a power supply switch transmitting a connection request message to a subscriber terminal; the power supply switch determining whether a response message to the connection request message has been received from the subscriber terminal; and the power supply switch supplying power together with data to the subscriber terminal upon a determination that a response message has been received from the subscriber terminal.

The method preferably further includes the power supply switch cutting off power supplied to the subscriber terminal upon a determination that a response message has not been received from the subscriber terminal.

The method preferably further includes the power supply switch transmitting the power supply control signal to cut off power supplied to the subscriber terminal upon a connection termination message being received from the subscriber terminal while power is being supplied to the subscriber terminal.

The connection termination message is preferably at least one of a power-line fault, a subscriber terminal fault, and a connection termination of the subscriber terminal.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1A is a functional block diagram of the configuration of a power-line communication system;

FIG. 1B is an equivalent circuit of when power and data are transmitted to the subscriber terminal of a subscriber over the power line in the Line Termination (LT) of an Integrated Services Digital Network (ISDN) switching office;

FIG. 2 is a functional block diagram of the configuration of a power-line communication system for supplying power and data to an ISDN subscriber terminal according to an embodiment of the present invention; and

FIG. 3 is a flowchart of a power-line communication method for supplying power and data to an ISDN subscriber terminal according to an embodiment of the present invention.

### DETAILED DESCRIPTION OF THE INVENTION

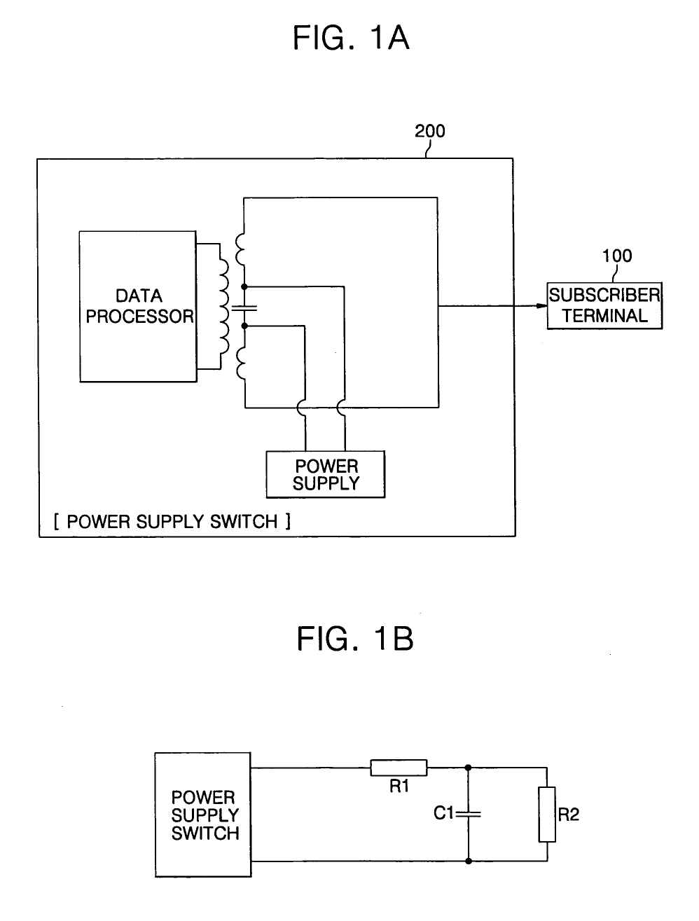

As shown in FIG. 1A, a power-line communication system includes a power supply for supplying power according to reference power, a data processor for superimposing data over power supplied by the power supply for data transmission, a voltage controller for adjusting a voltage of the reference power supplied through the power supply and converting the adjusted voltage to power according to the reference power for each provider, and a current controller for adjusting a current of the reference power supplied through the power supply and converting the adjusted current to power according to the reference power for each provider.

Such a power-line communication system refers to a technique of transmitting voice and data of an Integrated Service Digital Network (ISDN) digital subscriber together with power supply.

Accordingly, this is a technique related to ITU-T Recommendation G.961 and Power Feeding of ETSI ETR 080, which enables usage of a communication line without power in a remote place by supplying stable power from a Line Termination (LT) of ISDN to a subscriber terminal. Also, it supplies power based on user's safety with a function of controlling hardware and software with respect to contact with an adjacent line and an applied surge wave.

Also, a method of transmitting data in such a power-line communication system is a data communication technique of superimposing the data over DC power and transmitting it, and recovering the data at a receiving stage.

An equivalent circuit of when power and data are transmitted to the subscriber terminal of a subscriber over the power line in the LT of an ISDN switching office is illustrated in FIG. 1B, and the LT of the ISDN switching office stably supplies power regardless of the subscriber. A voltage, a current, and resistance supplied by the LT of the ISDN switching office are as shown in Table 1 below.

TABLE 1

| Voltage range | R1 [Ω] | C1 [μF] | R2 [Ω] | X [mA] |
|---|---|---|---|---|
| 51–69 V | 100 | 200 | 5000 | 45 |
| 66–70 V | 900 | 200 | 1000 | 40 |
| 91–99 V | 1000 | 400 | 3000 | 45 |
| 90–110 V | 1000 | 400 | 3000 | 40 |
| 105–115 V | 1000 | 400 | 3000 | 40 |

The maximum power supplied over the power line is 115 v×40 mA=4600 mW. Therefore, the maximum power that can be supplied over an ISDN subscriber line is 4600 mW. Unfortunately, this power level can be fatal for human beings and can damage other equipment.

Hereinafter, exemplary embodiments of the present invention are described in detail with reference to the accompanying drawings. While the present invention has been described with reference to exemplary embodiments thereof, it will be understood by those skilled in the art that various modifications in form and detail can be made therein without departing from the scope of the present invention as defined by the appended claims.

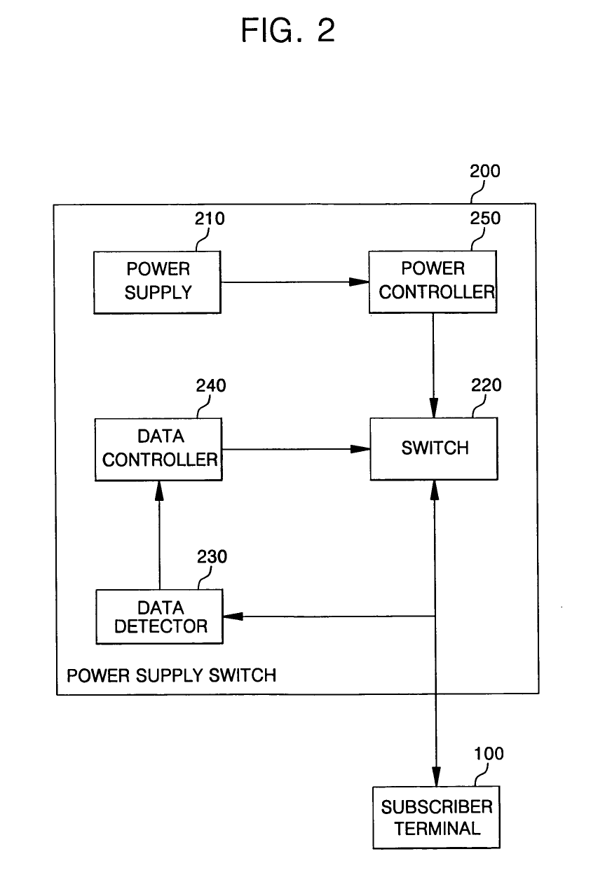

FIG. 2 illustrates the configuration of a power-line communication system for supplying power and data to an ISDN subscriber terminal according to an embodiment of the present invention. The power-line communication system for supplying power and data to an ISDN subscriber terminal includes a subscriber terminal 100, and a power supply switch 200, wherein the power supply switch 200 further includes a power supply 210, a switch 220, a data detector 230, a data controller 240, and a power controller 250.

The subscriber terminal 100 transmits a response message when a connection request message is received.

In addition, the power supply switch 200 transmits the connection request message to the subscriber terminal, and supplies power together with data to the subscriber terminal 100 when the response message to the connection request message is received from the subscriber terminal 100.

The power supply 210 in the power supply switch 200 supplies reference power to the subscriber terminal 100. The power that the power supply 210 can supply is as shown in Table 1 above.

The switch 220 in the power supply switch 200 performs a switching operation to supply power to the subscriber terminal 100 or to cut off the power according to a power supply control signal input from the data controller 240.

The data detector 230 in the power supply switch 200 detects whether a response message has been received from the subscriber terminal 100.

The data controller 240 in the power supply switch 200 transmits the connection request message to the subscriber terminal 100 to confirm a state of a connection with the subscriber terminal 100, and transmits the power supply control signal to the switch 220 to cut off power supplied to the subscriber terminal 100 when a response message is not received from the subscriber terminal 100 through the data detector 230.

The data controller 240 transmits the power supply control signal to the switch 220 and supplies power to the subscriber terminal 100 when the response message has been received from the subscriber terminal 100 through the data detector 230, and transmits the power supply control signal to the switch 220 and cuts off power supplied to the subscriber terminal 100 when a connection termination message is received from the subscriber terminal 100 while power is being supplied to the subscriber terminal 100.

The system further includes the power controller 250 for adjusting power supplied from the power supply 210, and converting the power to power for each provider. The power controller 250 includes a voltage controller for controlling a voltage supplied from the power supply 210, a current controller for controlling a current not to exceed a limit of a current illustrated in Table 1 above, and a protection unit for preventing a controller from being damaged by externally applied voltages and currents.

A connection termination message transmitted by the subscriber terminal 100 includes at least one of a power-line fault, a subscriber terminal 100 fault, and a connection termination of the subscriber terminal 100.

The data controller 240 in the power supply switch 200 first transmits a connection request message (INFO 2) to the subscriber terminal 100 to confirm a state of a connection subscriber terminal 100 through the data detector 230.

When the response message (INFO 3) has not been received from the subscriber terminal 100, the data controller 240 in the power supply switch 200 transmits a power supply control signal to the switch 220.

The switch 220 in the power supply switch 200 performs a switching operation to cut off power supplied to the subscriber terminal 100 according to the power supply control signal input from the data controller 240.

Subsequently, the power supplied to the subscriber terminal 100 through the power supply 210 is cut off.

The data controller 240 in the power supply switch 200 transmits the power supply control signal to the switch 220, when the response message (INFO 3) has been received from the subscriber terminal 100.

The switch 220 in the power supply switch 200 the performs a switching operation to supply power to the subscriber terminal 100 according to the power supply control signal input from the data controller 240.

Subsequently, power is supplied to the subscriber terminal 100 through the power supply 210. The power supplied through the power supply 210 is adjusted by the power controller 250. Each provider supplies the adjusted power.

As described above, the data controller 240 in the power supply switch 200 transmits the power supply control signal to the switch 220, when a connection termination message (INFO 0) is received from the subscriber terminal 100 and is confirmed by the data detector 230 while power is being supplied to the subscriber terminal 100 and a data communication is simultaneously being performed. The connection termination message (INFO 0) is at least one of a power-line fault, a subscriber terminal 100 fault, and a connection termination of the subscriber terminal 100.

The switch 220 in the power supply switch 200 then performs a switching operation to cut off power supplied to the subscriber terminal 100 according to the power supply control signal input from the data controller 240.

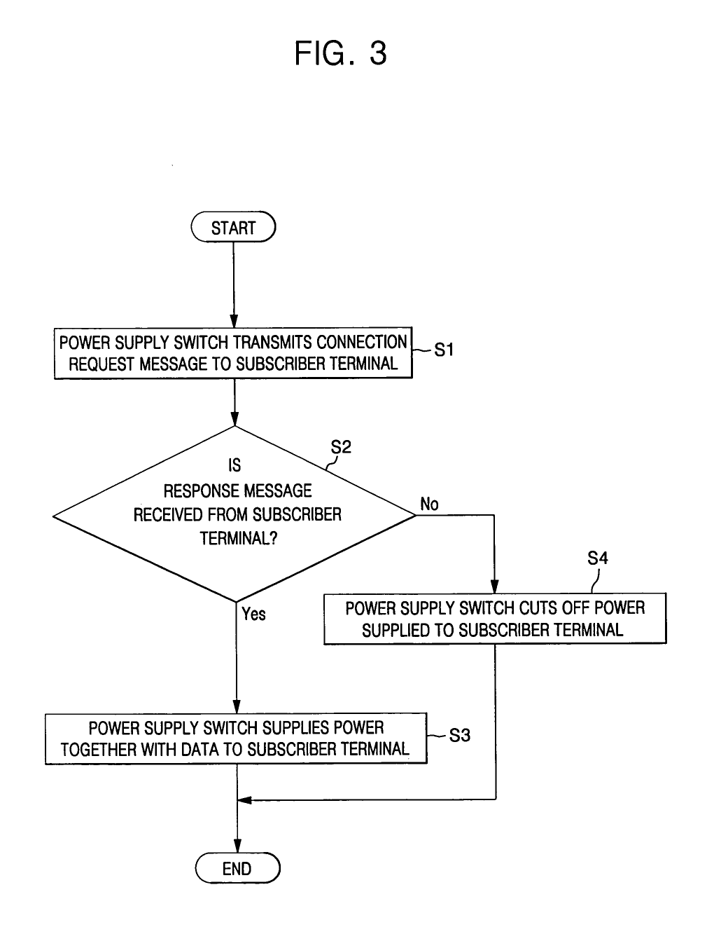

A power-line communication control method to supply power and data to an ISDN subscriber terminal according to the present invention is described below with reference to FIG. 3.

A power supply switch 200 transmits a connection request message to a subscriber terminal 100 (S1).

Furthermore, the power supply switch 200 determines whether a response message to the connection request message has been received from the subscriber terminal 100 (S2).

If the response message has been received from the subscriber terminal 100, the power supply switch 200 supplies power together with data to the subscriber terminal 100 (S3).

If a response message is not received from the subscriber terminal 100, the power supply switch 200 does not supply power to the subscriber terminal 100 (S4).

Also, when a connection termination message is received from the subscriber terminal 100 while power is being supplied to the subscriber terminal 100, the power supply switch 200 transmits a power supply control signal to cut off power supplied to the subscriber terminal 100. The connection termination message is at least one of a power-line fault, a subscriber terminal 1100 fault, and a connection termination of the subscriber terminal 100.

With the power-line communication system for supplying power and data to an ISDN subscriber terminal and a control method thereof according to the present invention as described above, it is possible to supply stable power by sensing a signal generated on an actual connection signal flow and applying the sensed signal to the checking of a line fault, thereby preventing a malfunction from occurring when a detecting device fails in a hardware detecting scheme.

While the present invention has been described with reference to exemplary embodiments thereof, it will be understood by those skilled in the art that various modifications in form and detail can be made therein without departing from the scope of the present invention as defined by the following claims.

What is claimed is:

1. A power-line communication system to supply power and data to an Integrated Service Digital Network (ISDN) subscriber terminal, the system comprising:
a subscriber terminal adapted to transmit a response message upon a connection request message being received; and
a power supply switch adapted to transmit the connection request message to the subscriber terminal, and to supply power together with data to the subscriber terminal upon the response message to the connection request message being received from the subscriber terminal.

2. The system of claim 1, wherein the power supply switch is adapted to cut off the power supplied to the subscriber terminal upon the response message to the connection request message not being received from the subscriber terminal.

3. The system of claim 1, wherein the power supply switch comprises;
a power supply adapted to supply a reference power;
a switch adapted to perform a switching operation to supply power to the subscriber terminal or to cut off the power according to a power supply control signal input;
a data detector adapted to detect the response message received from the subscriber terminal; and
a data controller adapted to transmit the connection request message to the subscriber terminal to confirm a state of a connection with the subscriber terminal, and to transmit the power supply control signal to the switch to cut off power supplied to the subscriber terminal upon the response message not being received from the subscriber terminal.

4. The system of claim 3, further comprising a power controller adapted to adjust power supplied through the power supply, and to convert the adjusted power to power for each provider.

5. The system of claim 3, wherein the data controller is adapted to transmit the power supply control signal to the switch upon the response message being received from the subscriber terminal through the data detector, to thereby supply power to the subscriber terminal.

6. The system of claim 3, wherein the data controller is adapted to transmit the power supply control signal to the switch upon a connection termination message being received from the subscriber terminal while power is being supplied to the subscriber terminal, the power supply control signal cutting off power supplied to the subscriber terminal.

7. The system of claim 6, wherein the connection termination message is at least one of a power-line fault, a subscriber terminal fault, and connection termination of the subscriber terminal.

8. A method of controlling a power-line communication system to supply power and data to an Integrated Service Digital Network (ISDN) subscriber terminal, the method comprising:
a power supply switch transmitting a connection request message to a subscriber terminal;
the power supply switch determining whether a response message to the connection request message has been received from the subscriber terminal; and
the power supply switch supplying power together with data to the subscriber terminal upon a determination that a response message has been received from the subscriber terminal.

9. The method of claim 8, further comprising the power supply switch cutting off power supplied to the subscriber terminal upon a determination that a response message has not been received from the subscriber terminal.

10. The method of claim 8, further comprising the power supply switch transmitting the power supply control signal to cut off power supplied to the subscriber terminal upon a connection termination message being received from the subscriber terminal while power is being supplied to the subscriber terminal.

11. The method of claim 10, wherein the connection termination message is at least one of a power-line fault, a subscriber terminal fault, and a connection termination of the subscriber terminal.
